(19) United States
(12) Patent Application Publication
(10) Pub. No.: US 2013/0156926 A1
(43) Pub. Date: Jun. 20, 2013

(54) MILK COLLAGEN JELLY SYSTEM, COLLAGEN JELLY SYSTEM, AND WITH INGREDIENTS

(71) Applicant: Alice Chang, Los Angeles, CA (US)

(72) Inventor: Alice Chang, Los Angeles, CA (US)

(21) Appl. No.: 13/459,380

(22) Filed: Apr. 30, 2012

Related U.S. Application Data
(60) Provisional application No. 61/570,360, filed on Dec. 14, 2011.

(51) Int. Cl. A23C 9/154; A23C 11/02; A23C 11/10

(52) U.S. Cl. 426/576

(57) ABSTRACT

Milk Collagen Jelly provides consumers with a food item that tastes good and is also good for them. The invention may be created by combining milk with gelatin and sugar. Instead of white sugar, the recipe can also be created with brown sugar, syrup or honey, artificial sweeteners or without sugar. Gelatin is the processed version of structural protein called collagen. The gelatin can come from the collagen in fish or pig bones, hides and connective tissues. It congeals at 15 degrees Celsius (or 59 degrees Fahrenheit). The product may be packaged in separate individual plastic, paper, metal or glass containers measuring about 3″ high, 3″ long and 3″ wide. Another packaging option may place the product into small spherical shapes of about ¼″ to ½″ in diameter, so that they can be mixed into iced coffee, iced tea, juices, and ice cream such that they may be readily ingestible.

### CROSS-REFERENCE TO RELATED APPLICATION

The present application is related to and claims priority from prior provisional application Ser. No. 61/570,360, filed Dec. 14, 2011 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. FIELD OF THE INVENTION

The present invention relates generally to the field of food and beverage compositions and more specifically relates to food and beverage compositions comprising collagen.

### 2. DESCRIPTION OF THE RELATED ART

Collagen is a group of naturally occurring proteins found in animals, especially in the flesh and connective tissues of mammals. It is the main component of connective tissue, and is the most abundant protein in mammals, making up about 25% to 35% of the whole-body protein content. Collagen, in the form of elongated fibrils, is mostly found in fibrous tissues such as tendon, ligament and skin, and is also abundant in cornea, cartilage, bone, blood vessels, the gut, and intervertebral disc. The fibroblast is the most common cell which creates collagen. Gelatin, which is used in food and industry, is collagen that has been irreversibly hydrolyzed.

In muscle tissue, collagen serves as a major component of the endomysium. Collagen constitutes one to two percent of muscle tissue, and accounts for 6% of the weight of strong, tendinous muscles. Collagen strengthens the body's connective tissues and allows them to be elastic. As people get older, their body makes less collagen and individual collagen fibers become increasingly cross-linked with each other, and they may experience stiff joints from less flexible tendons or wrinkles due to loss of skin elasticity. Therefore, consumers need an effective and natural way to restore collagen to the body to promote their health and well-being.

Various attempts have been made to solve the above-mentioned problems such as those found in U.S. Pat. and Pub. Nos. 2010/0068342; 2005/0053710; 6,919,306; 7,229,658; 2006/0004026; and 2005/0048128. This prior art is representative of food and beverage compositions comprising collagen. None of the above inventions and patents, taken either singly or in combination, is seen to describe the invention as claimed.

Ideally, a collagen containing food and/or beverage composition should be healthy and safe for ingestion and, yet would operate reliably and be manufactured at a modest expense. Thus, a need exists for a reliable Milk Collagen Jelly System to provide consumers with a healthy food option along with providing an edible way to replace lost collagen and to avoid the above-mentioned problems.

### BRIEF SUMMARY OF THE INVENTION

In view of the foregoing advantages inherent in the known food and beverage compositions art, the present invention provides a novel Milk Collagen Jelly System. The general purpose of the present invention, which will be described subsequently in greater detail is to provide consumers with a healthy food option along with providing an edible way to replace lost collagen.

Milk Collagen Jelly System of the present invention provides consumers with a healthy food option. This unique invention is preferably white in color and may be comprised of dairy milk, soy milk, almond milk, or coconut milk, and two basic ingredients: gelatin and sugar. The gelatin created and used as discussed herein is a processed version of a structural protein called collagen which has many health benefits. This innovative product may put back some of the collagen that the body naturally loses over time. It can be served for breakfast, as a dessert, or as a snack. Individuals who want to look and feel their best may benefit from this present invention.

A recipe for a Milk Collagen Jelly System is disclosed herein preferably comprising ingredients combined in proportions substantially including: milk (dairy milk, soy milk, almond milk, or coconut milk); gelatin; and sugar (white sugar, brown sugar, syrup or honey; artificial sweeteners or without sugar). The milk, the gelatin, and the sugar in combination, when ingested, are useful to replace collagen that a human body naturally loses over time to provide a health benefit to a consumer. The product gelatin may comprise collagen in fish or pig bones, hides and connective tissues. It congeals below 59 degrees Fahrenheit (or 15 degrees Celsius). The product may be packaged in separate individual plastic, paper, metal or glass containers measuring about 3″ high, 3″ long and 3″ wide. Another packaging option may place the product into small spherical shapes of about ¼″ to ½″ in diameter, so that they can be mixed into iced coffee, iced tea, juices, and ice cream such that they may be readily ingestible by humans for promotion of an individual's health and complexion.

The present invention holds significant improvements and serves as a Milk Collagen Jelly System. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, Milk Collagen Jelly System constructed and operative according to the teachings of the present invention.

FIG. 1 shows a perspective view illustrating a square packaging option for milk collagen jelly system according to an embodiment of the present invention.

FIG. 2 is a perspective view illustrating a six-pack of individually packed milk collagen jelly portions ready to consume according to an embodiment of the present invention of FIG. 1.

FIG. 3 is a perspective view illustrating small spheres of milk collagen jelly that may be mixed into solids or liquids according to an embodiment of the present invention of FIGS. 1 & 2.

FIG. 4 is a perspective view illustrating milk collagen jelly portions in a form ready to mix in a beverage according to an embodiment of the present invention of FIG. 1.

FIG. 5 is another perspective view illustrating the milk collagen jelly system ready to consume in beverage form according to an embodiment of the present invention of FIG. 1.

The various embodiments of the present invention will hereinafter be described in conjunction with the appended drawings, wherein like designations denote like elements.

### DETAILED DESCRIPTION

As discussed above, embodiments of the present invention relate to a food and beverage compositions and more specifically relates to food and beverage compositions comprising collagen to provide consumers with a healthy food option along with providing an edible way to replace lost collagen.

Generally speaking, Milk Collagen Jelly System of the present invention provides consumers with a food item that tastes good and is also good for them. The invention may be created by combining dairy milk (such as skim milk or whole milk), soy milk, almond milk, or coconut milk, with gelatin and sugar. Instead of white sugar, the recipe can also be created with brown sugar, honey, syrup, artificial sweeteners or without sugar. Gelatin referred to herein is a processed version of a structural protein called collagen. The gelatin can come from the collagen preferably found in fish or pig bones, hides and connective tissues. It congeals below 15 degrees Celsius (or 59 degrees Fahrenheit). The product may be packaged in separate individual plastic, paper, metal or glass containers measuring about 3″ high, 3″ long and 3″ wide (or different dimensions in alternate embodiments/portion sizes.) Another packaging option may place the product into small spherical shapes of about ¼″ to ½″ in diameter, so that they can be mixed into iced coffee, iced tea, juices, and ice cream.

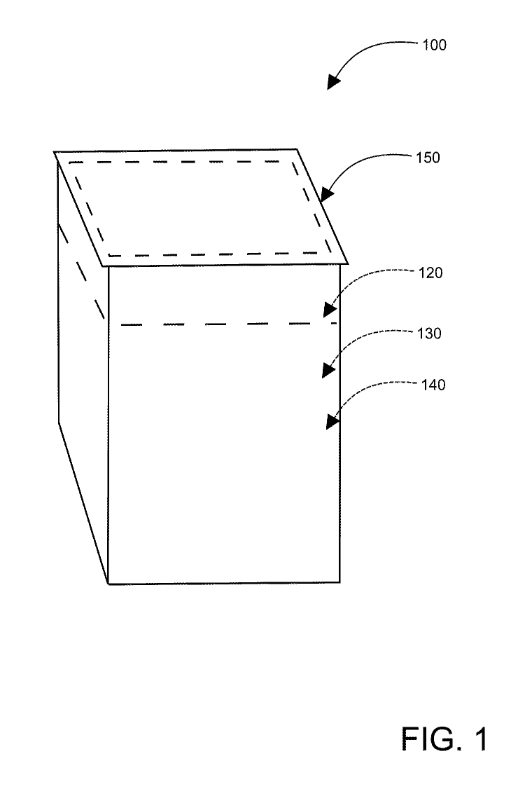

Referring to the drawings by numerals of reference there is shown in FIGS. 1 & 2, perspective views illustrating Milk Collagen Jelly System 100 in various packaging configurations according to an embodiment of the present invention.

A recipe for Milk Collagen Jelly System 100 is disclosed herein comprising ingredients combined in proportions substantially including: milk 120; gelatin 130; and sugar 140. Milk 120, gelatin 130; and sugar 140 in combination, when ingested, are useful to replace collagen that a human body naturally loses over time to provide a health benefit to a consumer. It should be noted that milk 120 may comprise dairy milk, soy milk, almond milk, or coconut milk. Sugar 140 may comprise white sugar, brown sugar, honey, syrup or artificial sweeteners.

Additional ingredients maybe added on top of the mentioned ingredients in forming the Milk Collagen Jelly System With Ingredients. These additional ingredients may include but are not limited to coffee, espresso, chocolate, cocoa, mint, vanilla, cinnamon, caramel, chocolate chip, marshmallow, ice cream, yogurt, cheese, cream, fruit juice, fruit, mixed fruit juice, mixed fruit, fruit skin drink, apple juice, orange juice, grape juice, cranberry juice, watermelon juice, honeydew juice, pineapple juice, guava juice, mango juice, coconut juice, banana juice, plum juice, prune juice, blackberry juice, blueberry juice, raspberry juice, pomegranate juice, lemon juice, lime juice, grapefruit juice, melon juice, cantaloupe juice, peach juice, pear juice, papaya juice, mandarin juice, apricot juice, Noni juice, Darian juice, tea, green tea, white tea, yellow tea, black tea, oolong tea, peppermint tea, chamomile tea, jasmine tea, Chinese tea, English Breakfast tea, Earl Grey tea, beaten egg, beaten egg yolk, egg white, vegetable juice, carrot juice, celery juice, cucumber juice, tomato juice, potato, taro, mashed potato, mashed taro, bean curd, avocado, yam, pea, chickpea, lentil, mushroom, eggplant, cucumber, zucchini, squash, beet, turnip, radish, onion, corn, nut, almond, pistachio, macadamia, pecan, acorn, walnut, hazelnut, chestnut, peanut, sesame, bean, red bean, green bean, black bean, white bean, soybean, cereal, rice, oat, wheat, barley, cooked rice, cooked oat, cooked wheat, cooked barley, soup, chicken broth, clam juice, clam chowder, beef broth, cream of mushroom soup, chicken noodle soup, minestrone, pea soup, etc.

Milk Collagen Jelly With Ingredients include the following: Milk Collagen Jelly with Coffee, Milk Collagen Jelly with Chocolate, Milk Collagen Jelly with Vanilla, Milk Collagen Jelly with Ice Cream, Milk Collagen Jelly with Yogurt, Milk Collagen Jelly with Cheese, Milk Collagen Jelly with Fruit Juice, Milk Collagen Jelly with Fruit, Milk Collagen Jelly with Fruit Skin Drink, Milk Collagen Jelly with Tea, Milk Collagen Jelly with Egg, Milk Collagen Jelly with Cooked Vegetable, Milk Collagen Jelly with Powdered Vegetable, Milk Collagen Jelly with Mashed Vegetable, Milk Collagen Jelly with Vegetable Juice, Milk Collagen Jelly with Potato, Milk Collagen Jelly with Mashed Potato, Milk Collagen Jelly with Bean Curd, Milk Collagen Jelly with Nut, Milk Collagen Jelly with Powdered Nut, Milk Collagen Jelly with Cereal, Milk Collagen Jelly with Cooked Cereal, Milk Collagen Jelly With Cooked Grain, Milk Collagen Jelly with Soup, etc. Thus, a wide number of variations are possible.

It should be noted that replacing milk with water makes the Collagen Jelly With Ingredients. Collagen Jelly With Ingredients include the following: Collagen Jelly with Coffee, Collagen Jelly with Chocolate, Collagen Jelly with Ice Cream, Collagen Jelly with Yogurt, Collagen Jelly with Cheese, Collagen Jelly with Fruit Juice, Collagen Jelly with Fruit, Collagen Jelly with Fruit Skin Drink, Collagen Jelly with Tea, Collagen Jelly with Egg, Collagen Jelly with Cooked Vegetable, Collagen Jelly with Powdered Vegetable, Collagen Jelly with Mashed Vegetable, Collagen Jelly with Vegetable Juice, Collagen Jelly with Potato, Collagen Jelly with Mashed Potato, Collagen Jelly with Bean Curd, Collagen Jelly with Nut, Collagen Jelly with Powdered Nut, Collagen Jelly with Cereal, Collagen Jelly with Cooked Cereal, Collagen Jelly with Cooked Grain, Collagen Jelly with Soup, etc.

Since gelatin 130 can be thick or soft in the texture, the amount of milk 120 can vary to create varying thickness (consistencies) of milk collagen jelly systems 100. Gelatin 130 may preferably be derived from either fish bones or pig bones, as previously mentioned. Further, gelatin may also be found in beef and pork skin, bone or beef bone tendon, split cattle hide, fish, crustaceans, etc. Gelatin congeals below 15 degrees Celsius in preferred embodiments. Further, the amount of sugar 140 can vary to create varying sweetness of milk collagen jelly systems 100.

The quantities given are for a preferred mixture(s) but may be varied according to the desired flavor and/or texture and end product. The proportions given are relative to each other and if varying the total quantity of the finished product, one must be aware of the necessity to increase or decrease each ingredient proportionately.

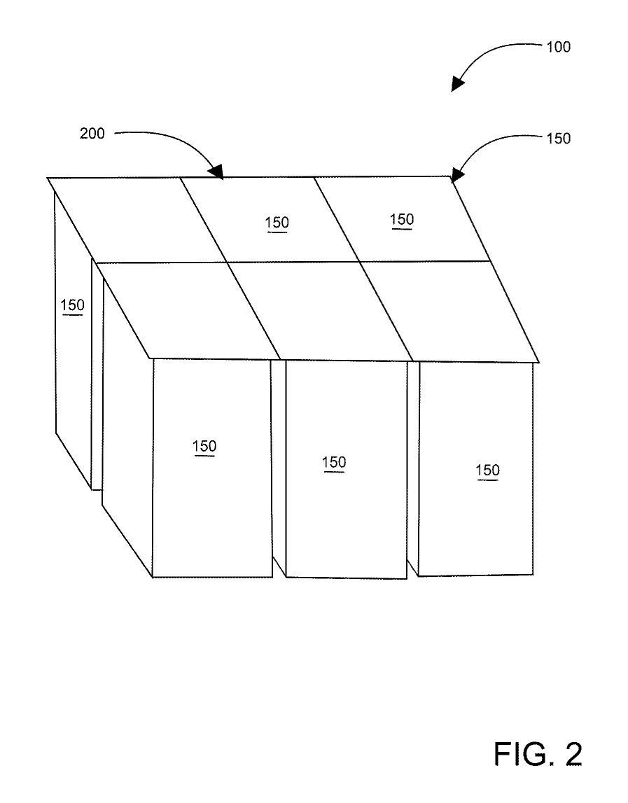

Milk Collagen Jelly System 100 may be individually packaged in container(s) 150 as shown in FIG. 1. Milk Collagen Jelly System 100 may also be sold in six-pack configuration 200 having six container(s) 150 assembled into one unit for purchase as shown in FIG. 2. Container(s) 150 preferably measure about 3″ high, 3″ long and 3″ wide. Container 150 may be manufactured from plastic. Upon reading this specification, it should be appreciated that, under appropriate circumstances, considering such issues as user preferences, design preference, structural requirements, marketing preferences, cost, available materials, technological advances, etc., other container material arrangements such as, for example, glass, metal, paper, etc., may be sufficient. Also the present invention may be manufactured and sold in different portion sizes and/or sizes/shapes.

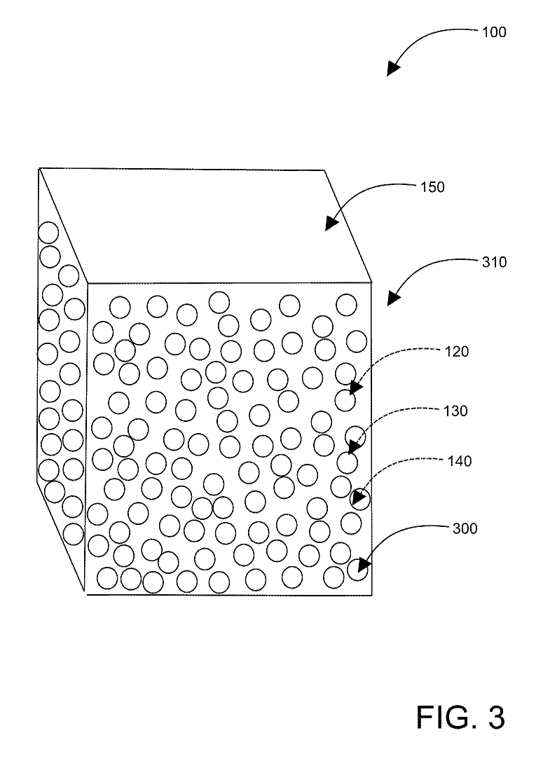

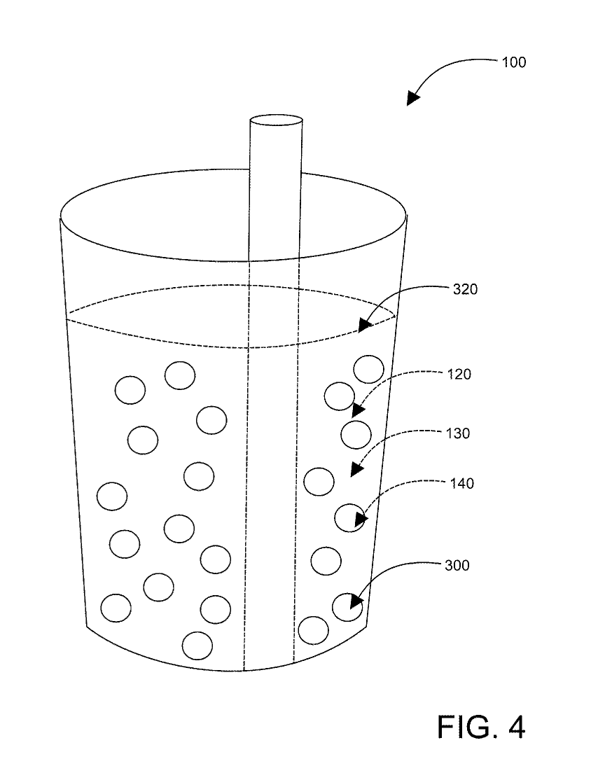

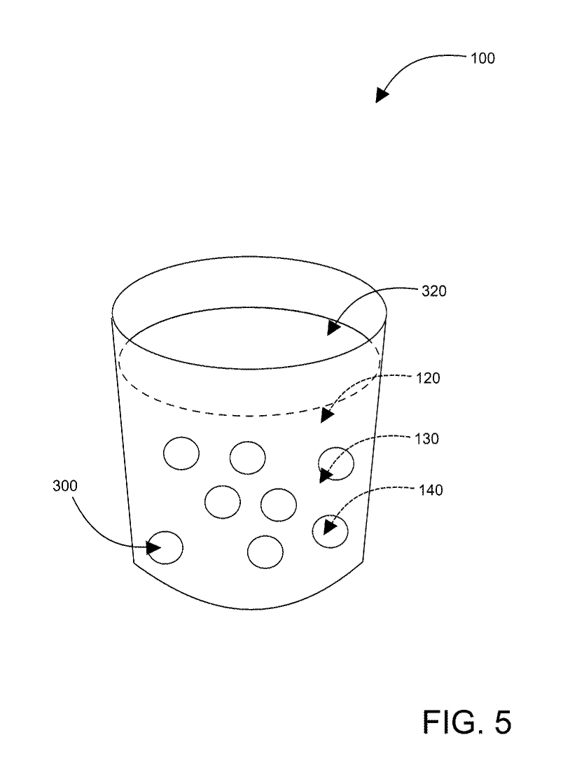

Referring now to FIGS. 3-5 showing perspective views illustrating small spheres 300 that may be mixed into solid(s) 310 or liquids 320 of Milk Collagen Jelly System 100 according to an embodiment of the present invention of FIGS. 1 & 2.

Another packaging option for Milk Collagen Jelly System 100 may be to place Milk Collagen Jelly System 100 into small spherical shapes 300 preferably having diameters ranging in size from about ¼-inch to about ½-inch. Spherical shapes 300 of milk collagen jelly systems 100 may be mixable in at least one liquid 320 and/or solid(s) 310. The at least one liquid 320 and/or solid(s) 310 may include but is not limited to iced coffee, iced tea, juices, and ice cream. In this way the present invention may be readily ingestible by human consumers in a variety of ways.

A method of use for Milk Collagen Jelly System 100 preferably comprises the steps of: mixing whole milk, lowfat milk, nonfat milk, soy milk, almond milk, or coconut milk and gelatin together creating a mixture; boiling said mixture; adding an optional sweetener such as sugar, syrup, honey, or artificial sweetener; cooling said mixture; adding additional ingredients such as coffee, chocolate, cocoa, mint, chocolate chip, fruit juice, fruit, etc.; refrigerating said mixture to congeal; and serving said mixture.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A recipe for a Milk Collagen Jelly System comprising ingredients combined in proportions substantially including:
milk;
gelatin; and
sugar;
wherein said milk, said gelatin; and said sugar in combination, when ingested, are useful to replace collagen that a human body naturally loses over time to provide a health benefit to a consumer.

2. The recipe of claim 1 wherein said milk comprises dairy milk.

3. The recipe of claim 1 wherein said milk comprises soy milk.

4. The recipe of claim 1 wherein said milk comprises almond milk.

5. The recipe of claim 1 wherein said milk comprises coconut milk.

6. The recipe of claim 1 wherein said sugar comprises white sugar.

7. The recipe of claim 1 wherein said sugar comprises brown sugar.

8. The recipe of claim 1 wherein said sugar comprises honey.

9. The recipe of claim 1 wherein said sugar comprises artificial sweeteners.

10. The recipe of claim 1 wherein said gelatin is from collagen in fish bones.

11. The recipe of claim 1 wherein said gelatin is from collagen in pig bones.

12. The recipe of claim 12 wherein said gelatin congeals at 15 degrees Celsius.

13. The recipe of claim 1 wherein said recipe is individually packaged in containers.

14. The recipe of claim 13 wherein said container(s) comprise plastic measuring about 3″ high, 3″ long and 3″ wide.

15. The recipe of claim 13 wherein said container(s) comprise glass measuring about 3″ high, 3″ long and 3″ wide.

16. The recipe of claim 13 wherein said container(s) comprise paper measuring about 3″ high, 3″ long and 3″ wide.

17. The recipe of claim 13 wherein said recipe is packaged in small spherical shapes of about ¼″ to ½″ in diameter.

18. The recipe of claim 17 wherein said recipe is mixable in at least one liquid.

19. The recipe of claim 17 wherein said recipe is mixable in at least one solid.

20. A method of producing a Milk Collagen Jelly System comprising the steps of:
mixing milk and gelatin together creating a mixture;
boiling said mixture;
adding a sweetener;
cooling said mixture;
adding at least one additional ingredient;
refrigerating said mixture to congeal; and
serving said mixture.
